(19) United States
(12) Patent Application Publication
(10) Pub. No.: US 2015/0198740 A1
(43) Pub. Date: Jul. 16, 2015

(54) ORGANIC-INORGANIC HYBRID COMPOSITION, PRODUCTION METHOD FOR SAME, AND OPTICAL SHEET AND OPTICAL DEVICE OF SAME

(71) Applicant: CHANGKANG CHEMICAL CO., LTD., Ansan-si, Gyeonggi-do (KR)

(72) Inventors: Woong Lin Hwang, Gunpo-si (KR); Hong Rok Kim, Ansan-si (KR); Chang Hwan Seo, Ansan-si (KR)

(21) Appl. No.: 14/407,251

(22) PCT Filed: Jun. 11, 2013
(86) PCT No.: PCT/KR2013/005151

§ 371 Date: Mar. 27, 2015

(30) Foreign Application Priority Data
Jun. 11, 2012 (KR) 10-2012-0062242
Jun. 11, 2013 (KR) 10-2013-0066259

(51) Int. Cl. G02B 1/04; G02B 5/04; C09K 11/77; C09K 11/66; C09K 11/64

(52) U.S. Cl. CPC G02B 1/04; C09K 11/66; C09K 11/64; C09K 11/7715; G02B 5/045

(57) ABSTRACT

An organic-inorganic hybrid composition comprising: zirconia particles containing at least one substance selected from aluminum, tin, and cerium; and a curable resin in which the metal-containing zirconia particles are dispersed, and a production method for the organic-inorganic hybrid composition are provided. The present invention also provides a production method for the organic-inorganic hybrid composition. The occurrence of yellowing due to light exposure can be effectively suppressed while not lowering the light transmittance and luminance of an optical sheet produced using the composition.

### CROSS-REFERENCE TO RELATED APPLICATIONS

This application claims priority under 35 USC §119(a) of Korean Patent Applications Nos. 10-2012-0062242 filed on Jun. 11, 2012, and 10-2013-0066259 filed on Jun. 11, 2013, the subject matters of which are hereby incorporated by references.

### BACKGROUND

1. Field of the Invention

The present invention relates to an organic-inorganic hybrid composition, a production method for the same, an optical sheet, and an optical device including the same, and more particularly, to an organic-inorganic hybrid composition for producing an optical sheet, a production method for the same, an optical sheet, and an optical device including the same.

2. Background Art

In liquid crystal display devices (LCD) as a kind of display devices, liquid crystals do not autonomously emit light but simply serve to transmit or block light according to applied electric signals. Therefore, a backlight unit (BLU) that is a surface emission device configured to illuminate a panel from the rear of the panel is required to supply light on the panel of the liquid crystal display device. The backlight unit may include a light source configured to radiate light, a light guide plate configured to uniformly disperse the light radiated from the light source, and an optical sheet configured to diffuse and intensify the light vertically emitting from the light guide plate so that the light uniformly reaches liquid crystal display the panel.

The optical sheet may include a diffusion film configured to scatter light a prism sheet configured to concentrate light spreading outwards therefrom to improve luminance in front of the panel, and the like. Here, the diffusion film serves to diffuse the light emitted through a top surface of the light guide plate so as to make the luminance uniform and widen a viewing angle. However, the light passing through the diffusion film may exhibit poor front emission luminance. A device used to enhance the vertical luminance is the prism sheet. However, when a plurality of sheets are stacked to enhance performance of the prism sheet, a lot of parts are required, resulting in a complicated manufacturing process and an increase in manufacturing costs.

As a transparent material of the prism sheet, a thermoplastic acrylic resin has high light transmittance, excellent optical properties, molding processability, high surface hardness, and superior mechanical strength, and thus has been widely used in a variety of industrial products including automobiles and home appliances, and optical devices. However, the acrylic resin has a problem in that, when the acrylic resin is exposed to light including ultraviolet (UV) rays, yellowing may occur, resulting in degraded transparency. Methods of adding a UV absorber are known in the related art to solve the problems. However, the method of adding a UV absorber has problems in that luminance may be degraded, and poor extraction may be caused in a reliability test.

### SUMMARY OF THE INVENTION

### Technical Problem

Therefore, the present invention is designed to solve the problems of the prior art, and it is an object of the present invention to provide an organic-inorganic hybrid composition capable of preventing degradation of luminance and improving reliability.

It is another object of the present invention to provide a production method for the composition.

It is still another object of the present invention to provide an optical sheet formed of the composition, or an optical device including the same.

### Technical Solution

To solve the above problems, one aspect of the present invention provides an organic-inorganic hybrid composition according to one exemplary embodiment of the present invention, which includes zirconia particles containing at least one metal selected from the group consisting of aluminum (Al), tin (Sn), and cerium (Ce), and a curable resin in which the metal-containing zirconia particles are dispersed.

To solve the above problems, another aspect of the present invention provides a production method for the composition. The production method includes preparing zirconia particles containing at least one metal selected from the group consisting of aluminum (Al), tin (Sn), and cerium (Ce), and mixing a curable resin with the metal-containing zirconia particles.

To solve the above problems, still another aspect of the present invention provides an optical sheet formed of the composition.

To solve the above problems, yet another aspect of the present invention provides an optical device including the optical sheet.

### Effect of the Invention

According to the organic-inorganic hybrid composition according to one exemplary embodiment of the present invention, the production method for the same, and the optical sheet and the optical device including the same, the organic-inorganic hybrid composition includes zirconia particles containing at least one metal selected from the group consisting of aluminum (Al), tin (Sn), and cerium (Ce), and a curable resin in which the metal-containing zirconia particles are dispersed, and thus can be useful in effectively suppressing the occurrence of yellowing caused by light exposure without degrading light transmittance and luminance of the composition, thereby improving reliability of products.

Also, the organic-inorganic hybrid composition can be used in various optical devices such as prism sheets, etc.

### BRIEF DESCRIPTION OF DRAWINGS

FIG. 1 is a perspective view schematically showing a shape of a prism sheet.

FIG. 2 is a schematic view of a triangular prism in which a ridge is in a round shape.

FIGS. 3 and 4 are exploded views showing schematic configurations of backlight units, respectively.

### DETAILED DESCRIPTION OF THE INVENTION

The organic-inorganic hybrid composition according to one exemplary embodiment of the present invention includes a zirconia particles containing at least one metal selected from the group consisting of aluminum (Al), tin (Sn), and cerium (Ce), and a curable resin in which the metal-containing zirconia particles are dispersed.

By way of another example, the metal-containing zirconia particles may further include chromium in addition to the aluminum, tin, and/or cerium. Therefore, the zirconia particles used in the organic-inorganic hybrid composition according to one exemplary embodiment of the present invention may include at least particles selected from the group consisting of zirconia particles containing chromium together with one metal selected from the group consisting of aluminum, tin, and cerium, zirconia particles containing chromium together with two metals selected from the group consisting of aluminum, tin, and cerium, and zirconia particles containing all of aluminum, tin, cerium, and chromium.

Since the metal-containing zirconia particles further include aluminum (Al), tin (Sn), and/or cerium (Ce) which are lower priced than zirconium (Zr) unlike inorganic particles composed only of zirconia, the manufacture cost of the inorganic particles may be lowered. Also, when an optical sheet formed of the composition according to one exemplary embodiment of the present invention is applied to backlight units (BLUs), light transmittance and luminance may be properly adjusted according to the content(s) of aluminum, tin, and/or cerium. Also, when the metal-containing zirconia particles include chromium, the occurrence of yellowing in the composition or the optical sheet formed of the composition may be prevented due to the presence of chromium when the composition or the optical sheet is exposed to UV rays.

The organic-inorganic hybrid composition according to one exemplary embodiment of the present invention has advantages in that excellent physical properties may be realized in aspects of luminance and light transmittance, and the occurrence of yelling may be minimized.

The organic-inorganic hybrid composition has a high liquid refractive index. Specifically, the liquid refractive index of the organic-inorganic hybrid composition may be greater than or equal to 1.57. By way of example, the liquid refractive index of the organic-inorganic hybrid composition may be in a range of 1.57 to 1.61. On the other hand, the liquid refractive index may be in a range of 1.57 to 1.60. By way of another example, the liquid refractive index may be in a range of 1.58 to 1.60. In this case, the liquid refractive index may be a value measured when the metal-containing zirconia particles are present at a content of approximately 30 parts by weight to approximately 35 parts by weight (for example, 31 parts by weight), based on a total of 100 parts by weight of the organic-inorganic hybrid composition. In this case, the metal-containing zirconia particles may or may not further contain chromium.

When the organic-inorganic hybrid composition is applied to various devices, excellent luminance of the devices may be realized. Specifically, a device to which a film prepared using the organic-inorganic hybrid composition is applied may have a luminance which is improved by approximately 4% or more, compared to the luminance of a device to which a film, which is prepared using a resin composition including inorganic particles composed only of zirconia and has substantially the same thickness, is applied. Specifically, the luminance of the device to which the film prepared using the organic-inorganic hybrid composition according to one exemplary embodiment of the present invention may increase by approximately 5% or more or approximately 10% or more, for example, approximately 4% to approximately 20%, compared to that of the device to which the film prepared using the resin composition including the including inorganic particles composed only of zirconia. On the other hand, the luminance of the device to which the film prepared using the organic-inorganic hybrid composition is applied may be improved by approximately 5% to approximately 20%, or approximately 7% to approximately 15%, compared to that of the device to which the film prepared using the resin composition including the including the including inorganic particles composed only of zirconia.

By way of still another example, the film prepared using the organic-inorganic hybrid composition has a high light transmittance. For example, when a film having a thickness of approximately 60 μm is formed using the composition, the film may have a light transmittance of approximately 70% or more with respect to blue light with a wavelength of approximately 450 nm. For example, the light transmittance may be greater than or equal to approximately 74%, or approximately 77%. Specifically, the film may have a light transmittance of approximately 70% to approximately 85%, or approximately 70% to approximately 80%.

Meanwhile, the film prepared using the organic-inorganic hybrid composition may be used to effectively prevent or lower the occurrence of yellowing.

By way of example, when a specimen in the form of a film is manufactured as a cured product of the organic-inorganic hybrid composition, the specimen is subjected to a promotion weathering test under the conditions of ASTM D 4674, and a change in y-axis value of the Commission Internationale de L'Eclairage (CIE) color coordinates with respect to the specimen may satisfy the following Mathematical Expression 1.

Δy≦0.004 [Mathematical Expression 1]

In Mathematical Expression 1, Δy represents a change in each of the y-axis values of the CIE coordinate system before and after the promotion weathering test.

The CIE color coordinates are values measured according to a method of measuring the CIE 1931 color coordinates. By way of example, the Δy value of the specimen formed of the organic-inorganic hybrid composition may be less than or equal to approximately 0.004. Specifically, the Δy value may be less than or equal to approximately 0.0035. More specifically, the Δy value may be in a range of approximately 0.0005 to 0.004, or 0.001 to 0.0035. As described above, the cured product of the organic-inorganic hybrid composition may have a small change in the y-axis value of the CIE color coordinates.

Meanwhile, when the metal-containing zirconia particles of the organic-inorganic hybrid composition further include chromium, the cured product of the organic-inorganic hybrid composition may have a much smaller change in the y-axis value. For example, the cured specimen including the metal-containing zirconia particles further containing chromium may have a change in y-axis value of approximately 0.003 or less in the CIE color coordinates. Specifically, the change in y-axis value may be less than or equal to approximately 0.0028, more specifically approximately 0.0026. For example, the change in y-axis value may satisfy a range of approximately 0.001 to approximately 0.003. As described above, even when the organic-inorganic hybrid composition is applied to actual use conditions, yellowing may substantially hardly occur.

By way of example, in the metal-containing zirconia particles, the metal including aluminum, tin, and/or cerium may be present at a content of approximately 0.1 to 20 parts by weight, approximately 0.5 to 4 parts by weight, approximately 0.5 to 10 parts by weight, approximately 0.5 part by weight to approximately 15 parts by weight, approximately 1 to 10 parts by weight, approximately 1 to 15 parts by weight, approximately 5 to 15 parts by weight, or approximately 8 to 15 parts by weight, based on 100 parts by weight of zirconia. The organic-inorganic hybrid composition including the metal-containing zirconia particles having the content within this range may have improved processability, and thus light transmittance of the film prepared using the composition may also be improved. In addition, when the film is applied to an optical device, etc., luminance of the optical device may be improved.

By way of still another example, the metal-containing zirconia particles may further contain chromium in addition to aluminum, tin, and/or cerium. In the metal-containing zirconia particles further containing chromium, chromium may be further included at a content of approximately 0.01 part by weight to approximately 10 parts by weight, based on 100 parts by weight of the metal-containing zirconia particles. In this case, it is defined that chromium is not included in 100 parts by weight of the metal-containing zirconia. For example, chromium may be further included at a content of approximately 0.1 to 10 parts by weight, approximately 0.3 to 8 parts by weight, or approximately 0.2 to 5 parts by weight, based on 100 parts by weight of the metal-containing zirconia particles. The metal-containing zirconia particles containing chromium within this content range may effectively prevent the occurrence of yellowing without causing degradation of physical properties of the organic-inorganic hybrid composition.

In the total content of the organic-inorganic hybrid composition, the content of the metal-containing zirconia particles according to one exemplary embodiment of the present invention is not particularly limited as long as the content of the metal-containing zirconia particles does not inhibit dispersion of the metal-containing zirconia particles in the curable resin. For example, the metal-containing zirconia particles may be present at a content of approximately 5 to 70 parts by weight, based on 100 parts by weight of the curable resin. Specifically, the content of the metal-containing zirconia particles may be in a range of approximately 15 to 50 parts by weight, approximately 20 to 50 parts by weight, approximately 20 to 60 parts by weight, or approximately 45 to 50 parts by weight, based on 100 parts by weight of the curable resin. The composition including the metal-containing zirconia particles with this content range may realize high luminance and excellent light transmittance without hindering a degree of dispersion of the metal-containing zirconia particles.

The size of the metal-containing zirconia particles in the organic-inorganic hybrid composition is not particularly limited as long as the size of the metal-containing zirconia particles does not cause a decrease in the degree of dispersion. By way of example, the metal-containing zirconia particles may have an average particle diameter of 1 nm to 80 nm. Specifically, the average particle diameter of the metal-containing zirconia particles may be in a range of 5 nm to 80 nm, 10 nm to 30 nm, 1 nm to 4 nm, 1 nm to 20 nm, 30 nm to 50 nm, or 30 nm to 80 nm. In the present invention, the average particle diameter of the particles refers to an arithmetical average diameter of particles obtained by particle size analysis, for example, a size of particles provided in a typical optical system, that is, an average diameter of particles approximated in a spherical shape.

Types of the curable resin in the organic-inorganic hybrid composition are not particularly limited as long as the zirconia particles can be dispersed in the curable resin. By way of example, a certain curable resin may be used as the curable resin. Specifically, the curable resin may include a photocurable or thermosetting resin. For example, in the organic-inorganic hybrid composition, a UV-curable resin may be used as the curable resin.

By way of example, the curable resin may include a compound having a structure represented by the following Formula 1.

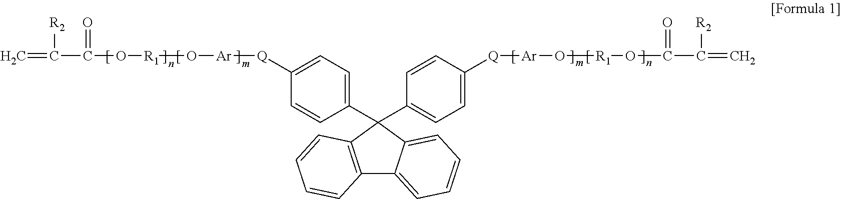

In Formula 1, R₁ represents an alkylene group having 2 to 10 carbon atoms, with which a hydroxyl group is unsubstituted or substituted, R₂ represent hydrogen, or a methyl group, Ar represents an arylene group having 6 to 40 carbon atoms, or a heteroarylene group having 3 to 40 carbon atoms, Q represents oxygen, or sulfur, and m and n each independently represent an integer ranging from 0 to 8.

In Formula 1, the alkylene group represented by R₁ may be represented by —(CH₂)ₓ—, where x represents an integer ranging from 2 to 10. In this case, the alkylene group may be a linear or branched carbon chain. At least one of hydrogen atoms in the alkylene group represented by R₁ may be unsubstituted or substituted with a hydroxyl group, or an alkyl group having 1 to 5 carbon atoms (—(CH₂)_{y}—CH₃ where y represents an integer ranging from 0 to 4).

By way of still another example, the curable resin may include a compound having a structure represented by the following Formula 2.

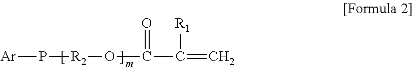

In Formula 2, R₁ represents hydrogen, or a methyl group, R₂ represents an alkylene group having 2 to 10 carbon atoms, with which a hydroxyl group is unsubstituted or substituted, Ar represents an aryl group having 6 to 40 carbon atoms, or a heteroaryl group having 3 to 40 carbon atoms, m represents an integer ranging from 0 to 8, and P represents oxygen, or sulfur.

In Formula 2, R₁ represents hydrogen, a methyl group, or a branched carbon chain, and the alkylene group represented by R₂ may be represented by —(CH₂)_{y}— where y represents an integer ranging from 2 to 10.

According to one exemplary embodiment, in Formula 2, R₁ may represent hydrogen, or a methyl group, R₂ may represent an alkylene group having 2 to 10 carbon atoms, with which a hydroxyl group is unsubstituted or substituted, Ar may represent phenyl, naphthyl, biphenyl, or triphenyl, m may represent an integer ranging from 1 to 8, and P may represent oxygen, or sulfur.

By way of yet another example, the curable resin may include a compound having a structure represented by the following Formula 3.

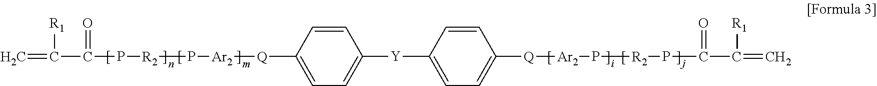

In Formula 3, R₁ represents hydrogen, or a methyl group, R₂ represents an alkylene group having 2 to 10 carbon atoms, with which a hydroxyl group is unsubstituted or substituted, Ar₂ each independently represent an arylene group having 6 to 40 carbon atoms, or a heteroarylene group having 3 to 40 carbon atoms, P represents oxygen, or sulfur, Q represents oxygen, or sulfur, and i, j, n, and m may each independently represent an integer ranging from 0 to 8. Also, Y represents —C(CH₃)₂—, —CH₂—, —S—,

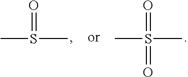

In Formula 3, R₁ represents hydrogen, or a methyl group, the alkylene group represented by R₂ may be represented by —(CH₂)_{y}— where y represents an integer ranging from 2 to 10.

For example, a UV-curable resin including at least one of the compounds having the structures represented by Formulas 1 to 3 may be used as the curable resin according to one exemplary embodiment of the present invention.

In the organic-inorganic hybrid composition according to one exemplary embodiment of the present invention, the surfaces of the metal-containing zirconia particles may be modified. Various methods may be used to modify the surfaces of the metal-containing zirconia particles. For example, in a process of producing the organic-inorganic hybrid composition, a surface modifying agent may be added to modify the surfaces of the metal-containing zirconia particles.

By way of example, the surface modifying agent may be a silane compound. For example, the silane compound may include at least one of compounds represented by the following Formulas 4 to 6.

(R³)ₘ—Si—X₍₄₋ₘ₎ [Formula 4]

(R³)ₘ—O—Si—X₍₄₋ₘ₎ [Formula 5]

(R³)ₘ—HR⁴—Si—X₍₄₋ₘ₎ [Formula 6]

R³ represents an alkyl group having 1 to 12 carbon atoms, an alkenyl group having 2 to 12 carbon atoms, an alkynyl group having 2 to 12 carbon atoms, an aryl group having 6 to 12 carbon atoms, a halogen, a substituted amino group, an amide group, an alkylcarbonyl group having 1 to 12 carbon atoms, a carboxyl group, a mercapto group, a cyano group, a hydroxyl group, an alkoxy group having 1 to 12 carbon atoms, an alkoxycarbonyl group having 1 to 12 carbon atoms, a sulfonate group, a phosphate group, an acryloxy group, a methacryloxy group, an epoxy group, or a vinyl group. In this case, when R³ represents an aryl group, one of hydrogen atoms in the aryl group may be unsubstituted or substituted with an alkyl group having 1 to 6 carbon atoms, an alkenyl group having 2 to 6 carbon atoms, or an alkynyl group having 2 to 6 carbon atoms.

Also, in each of Formulas 4 to 6, R⁴ represents H, or an alkyl group having 1 to 12 carbon atoms, X₄ represents hydrogen, a halogen, an alkoxy group having 1 to 12 carbon atoms, an acyloxy group having 1 to 12 carbon atoms, an alkylcarbonyl group having 1 to 12 carbon atoms, an alkoxycarbonyl group having 1 to 12 carbon atoms, or —N(R⁵)₂ (where R⁵ represents H, or an alkyl having 1 to 12 carbon atoms), and m represents an integer ranging from 1 to 3.

For example, specific examples of the silane compound that may be used herein may include isooctyl trimethoxy-silane, 3-(methacryloyloxy)propyltrimethoxysilane, 3-acryloxypropyltrimethoxysilane, 3-(methacryloyloxy)propyltriethoxysilane, 3-(methacryloyloxy)propylmethylmethoxysilane, 3-(acryloyloxypropyl)methyldimethoxysilane, 3-(methacryloyloxy)propyldimethyletlioxysilane, 3-(methacryloyloxy)propyldimethylethoxysilane, vinyldimethylethoxysilane, phenyltrimethoxysilane, n-octyltrimethoxysilane, dodecyltrimethoxysilane, octadecyltrimethoxysilane, propyltrimethoxysilane, hexyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyl triisopropenoxysilane, vinyltris(2-methoxyethoxy)silane, styrylethyltrimethoxysilane, mercaptopropyltrimethoxysilane, or 3-glycidoxypropyltrimethoxysilane, which may be used alone or in combination of two or more.

By way of another example, the surface modifying agent may be a carboxylic acid compound. For example, the surface modifying agent may include at least one of compounds having structures represented by the following Formulas 7 and 8.

(R⁵)ₘ—COOH [Formula 7]

(R⁵)ₘ—CH₂COOH [Formula 8]

In each of Formulas 7 and 8, R⁵ represents hydrogen, an alkyl group having 1 to 20 carbon atoms, an alkenyl group having 1 to 20 carbon atoms, an alkoxy group having 1 to 7 carbon atoms, an aryl group having 6 to 40 carbon atoms, or a heteroaryl group having 3 to 40 carbon atoms, m represents an integer ranging from 1 to 10, and R⁵ and hydrogen atoms of —(CH₂)ₘ— may be each independently substituted with at least one selected from the group consisting of an alkyl group having 1 to 10 carbon atoms, an alkoxy group having 1 to 10 carbon atoms, an alkenyl group having 1 to 10 carbon atoms, an aryl group having 3 to 20 carbon atoms, and a carboxyl group.

According to one exemplary embodiment, in each of Formulas 7 and 8, R⁵ may represent a methoxy group, a carboxyethyl group, an ethoxy group, a methoxyphenol group, or a methoxyethoxy group, and m may represent an integer ranging from 1 to 10.

For example, examples of the carboxylic acid compound may include acrylic acid, methacrylic acid, oleic acid, dodecanoic acid, 2-2-2-methoxyethoxyethoxyacetic acid, β-carboxyethylacrylate, 2-2-methoxyethoxyacetic acid, or methoxyphenyl acetic acid, which may be used alone or in combination of two or more.

In the organic-inorganic hybrid composition, the surface modifying agent may be included at a content of 0.1 to 40 parts by weight, 0.1 to 5 parts by weight, 1 to 20 parts by weight, 1 to 30 parts by weight, 5 to 10 parts by weight, or 5 to 20 parts by weight, based on 100 parts by weight of the metal-containing zirconia particles. When the surface modifying agent is added within this content range, an excellent surface modifying effect on the inorganic particles may be ensured so that the metal-containing zirconia particles can be easily dispersed in the curable resin.

Also, the present invention is directed to providing a production method for the organic-inorganic hybrid composition in which the above-described metal-containing zirconia particles are dispersed in the curable resin.

By way of example, the organic-inorganic hybrid composition according to one exemplary embodiment of the present invention may be produced by preparing zirconia particles containing aluminum, tin, and/or cerium, and then mixing the metal-containing zirconia particles with a curable resin. In this case, a surface modifying agent may be further mixed with the metal-containing zirconia particles and the curable resin. The metal-containing zirconia particles are substantially as described above, and thus an overlapping detailed description thereof is omitted for clarity.

By way of example, the metal-containing zirconia particles may be prepared by mixing an aluminum precursor, a tin precursor, and/or a cerium precursor with a zirconium precursor, and stirring and sonicating a mixture of the precursors. In this case, a chromium precursor may be further mixed to prepare the metal-containing zirconia particles.

Each of the zirconium precursor, the aluminum precursor, the tin precursor, the cerium precursor, and the chromium precursor refers to a category of precursors commercially available by those skilled in the related art. For example, zirconium acetate may be used as the zirconium precursor, aluminum isopropoxide may be used as the aluminum precursor, and tin acetate and cerium acetylacetonate may be used as the tin precursor and the cerium precursor, respectively. Chromium acetate may be used as the chromium precursor.

The stirring and sonicating of the mixture of the precursors is performed to dissolve precursor components by means of a sonication process. For example, ultrasonic waves may be applied to the mixture by applying a frequency of approximately 20 kHz or more. Specifically, when acoustic waves having a high energy of approximately 20 kHz or more is applied to a liquid, a cavitation phenomenon in which fine bubbles are repeatedly formed and destroyed approximately 25,000 to 30,000 times per second may occur. A chemical reaction and a dissipation action in the liquid may be promoted by means of such a cavitation phenomenon. At the same time, the cavitation phenomenon may serve to remove contaminants.

By way of another example, after the stirring and sonicating of the mixture of the precursors, the mixture of the precursors may react at a temperature of 200° C. to 350° C. and a pressure of 25 atm to 40 atm for 3 hours to 7 hours. Specifically, the mixture of the precursors is transferred to a liner autoclave having a capacity of approximately 1 L, and an inner temperature of the liner autoclave is set so that an inner pressure of the liner autoclave reaches 25 atm to 40 atm. When the inner pressure of the liner autoclave reaches 25 atm to 40 atm, the inner pressure may be maintained for 3 hours to 7 hours to produce the metal-containing zirconia particles according to one exemplary embodiment of the present invention.

In a process of producing the metal-containing zirconia particles, a drying process may be further performed, when necessary. For example, the metal-containing zirconia particles may be obtained by removing moisture from a colloidal solution, which include the metal-containing zirconia particles produced by reacting the mixture of the precursors under the conditions as described above and sonicating the mixture of the precursors, using a vent dryer or a spray dryer. A drying atmosphere is an atmospheric condition, and a drying temperature is a temperature at which an inorganic substance is dried without causing a change in physical properties of the inorganic substance. The drying temperature may be in a range of approximately 90° C. to approximately 110° C., and the drying time may be a time when the drying is performed until moisture is completely removed.

When the metal-containing zirconia particles are mixed with the curable resin, the mixing may be performed at a temperature of approximately 20° C. to approximately 150° C. for 10 minutes to 20 hours, or performed at a temperature of approximately 30° C. to approximately 150° C. for 3 hours to 10 hours. In the mixing of the metal-containing zirconia particles with the curable resin, various types of solvents may be further used. Thereafter, the mixture may be subjected under a vacuum condition to remove the added solvent. Here, the term “vacuum condition” refers to a condition which encompasses a sufficiently low atmospheric pressure condition to be actually realizable in laboratories, as well as a theoretical vacuum condition. The solvent is used to readily mix the surface modifying agent and the curable resin with the metal-containing zirconia particles and readily disperse the metal-containing zirconia particles in the curable resin. Examples of the solvent that may be used in the process as described above may include 1-methoxy-2-propanol, ethanol, isopropanol, ethylene glycol, methylene chloride, methanol, or acetone, which may be used alone or in combination of two or more.

Also, the present invention is directed to providing a cured product formed of the above-described organic-inorganic hybrid composition.

By way of example, the cured product may be in the form of a film. The cured product in the form of a film may be used as an optical sheet. For example, the cured product may be formed by applying light and/or heat to the organic-inorganic hybrid composition according to one exemplary embodiment of the present invention. Therefore, the cured product includes the metal-containing zirconia particles. A process of producing the cured product may be varied according to the types of the curable resin included in the organic-inorganic hybrid composition. In a process of forming the cured product, the shape of the cured product may also be widely determined according to the shape of a frame used to form the organic-inorganic hybrid composition.

For example, the optical sheet includes at least one optical layer having a micropattern formed therein, and the optical layer of the optical sheet may be formed of the organic-inorganic hybrid composition according to one exemplary embodiment of the present invention. Therefore, the optical layer includes the metal-containing zirconia particles. In this case, the micropattern may have a structure in which triangular cross-sectional shapes are repeatedly arranged.

As a specific example, the micropattern may be a prism pattern. In this case, the optical sheet may be a prism sheet. The prism sheet may be manufactured by curing a curable resin. Examples of the curable resin used to manufacture the prism sheet may be 2-phenoxyethyl acrylate, 2-phenoxyethyl (meth)acrylate, 3-phenoxypropyl acrylate, 3-phenoxypropyl (meth)acrylate, 4-phenoxybutyl acrylate, 4-phenoxybutyl (meth)acrylate, 5-phenoxypentyl acrylate, 5-phenoxypentyl (meth)acrylate, 6-phenoxyhexyl acrylate, 6-phenoxyhexyl (meth)acrylate, 7-phenoxyheptyl acrylate, 7-phenoxyheptyl (meth)acrylate, 8-phenoxyoctyl acrylate, 8-phenoxyoctyl (meth)acrylate, 9-phenoxynonyl acrylate, 9-phenoxynonyl (meth)acrylate, 10-phenoxydecyl acrylate, 10-phenoxydecyl (meth)acrylate, 2-(phenylthio)ethyl acrylate, 2-(phenylthio)ethyl (meth)acrylate, 3-(phenylthio)propyl acrylate, 3-(phenylthio)propyl (meth)acrylate, 4-(phenylthio)butyl acrylate, 4-(phenylthio)butyl (meth)acrylate, 5-(phenylthio)pentyl acrylate, 5-(phenylthio)pentyl (meth)acrylate, 6-(phenylthio)hexyl acrylate, 6-(phenylthio)hexyl (meth)acrylate, 7-(phenylthio)heptyl acrylate, 7-(phenylthio)heptyl (meth)acrylate, 8-(phenylthio)octyl acrylate, 8-(phenylthio)octyl (meth)acrylate, 9-(phenylthio)nonyl acrylate, 9-(phenylthio)nonyl (meth)acrylate, 10-(phenylthio)decyl acrylate, 10-(phenylthio)decyl (meth)acrylate, 2-(naphthalen-2-yloxy)ethyl acrylate, 2-(naphthalen-2-yloxy)ethyl (meth)acrylate, 3-(naphthalen-2-yloxy)propyl acrylate, 3-(naphthalen-2-yloxy)propyl (meth)acrylate, 4-(naphthalen-2-yloxy)butyl acrylate, 4-(naphthalen-2-yloxy)butyl (meth)acrylate, 5-(naphthalen-2-yloxy)pentyl acrylate, 5-(naphthalen-2-yloxy)pentyl (meth)acrylate, 6-(naphthalen-2-yloxy)hexyl acrylate, 6-(naphthalen-2-yloxy)hexyl (meth)acrylate, 7-(naphthalen-2-yloxy)heptyl acrylate, 7-(naphthalen-2-yloxy)heptyl (meth)acrylate, 8-(naphthalen-2-yloxy)octyl acrylate, 8-(naphthalen-2-yloxy)octyl (meth)acrylate, 9-(naphthalen-2-yloxy)nonyl acrylate, 9-(naphthalen-2-yloxy)nonyl (meth)acrylate, 10-(naphthalen-2-yloxy)decyl acrylate, 10-(naphthalen-2-yloxy)decyl (meth)acrylate, 2-(naphthalen-2-ylthio)ethyl acrylate, 2-(naphthalen-2-ylthio)ethyl (meth)acrylate, 3-(naphthalen-2-ylthio)propyl acrylate, 3-(naphthalen-2-ylthio)propyl (meth)acrylate, 4-(naphthalen-2-ylthio)butyl acrylate, 4-(naphthalen-2-ylthio)butyl (meth)acrylate, 5-(naphthalen-2-ylthio)pentyl acrylate, 5-(naphthalen-2-ylthio)pentyl (meth)acrylate, 6-(naphthalen-2-ylthio)hexyl acrylate, 6-(naphthalen-2-ylthio)hexyl (meth)acrylate, 7-(naphthalen-2-ylthio)heptyl, acrylate, 7-(naphthalen-2-ylthio)heptyl (meth)acrylate, 8-(naphthalen-2-ylthio)octyl acrylate, 8-(naphthalen-2-ylthio)octyl (meth)acrylate, 9-(naphthalen-2-ylthio)nonyl acrylate, 9-(naphthalen-2-ylthio)nonyl (meth)acrylate, 10-(naphthalen-2-ylthio)decyl acrylate, 10-(naphthalen-2-ylthio)decyl (meth)acrylate, 2-([1,1′-biphenyl]-4-yloxy)ethyl acrylate, 2-([1,1′-biphenyl]-4-yloxy)ethyl (meth)acrylate, 3-([1,1′-biphenyl]-4-yloxy)propyl acrylate, 3-([1,1′-biphenyl]-4-yloxy)propyl (meth)acrylate, 4-([1,1′-biphenyl]-4-yloxy)butyl acrylate, 4-([1,1′-biphenyl]-4-yloxy)butyl (meth)acrylate, 5-([1,1′-biphenyl]-4-yloxy)pentyl acrylate, 5-([1,1′-biphenyl]-4-yloxy)pentyl (meth)acrylate, 6-([1,1′-biphenyl]-4-yloxy)hexyl acrylate, 6-([1,1′-biphenyl]-4-yloxy)hexyl (meth)acrylate, 7-([1,1′-biphenyl]-4-yloxy)heptyl acrylate, 7-([1,1′-biphenyl]-4-yloxy)heptyl (meth)acrylate, 8-([1,1′-biphenyl]-4-yloxy)octyl acrylate, 8-([1,1′-biphenyl]-4-yloxy)octyl (meth)acrylate, 9-([1,1′-biphenyl]-4-yloxy)nonyl acrylate, 9-([1,1′-biphenyl]-4-yloxy)nonyl (meth)acrylate, 10-([1,1′-biphenyl]-4-yloxy)decyl acrylate, 10-([1,1′-biphenyl]-4-yloxy)decyl (meth)acrylate, 2-([1,1′-biphenyl]-4-ylthio)ethyl acrylate, 2-([1,1′-biphenyl]-4-ylthio)ethyl (meth)acrylate, 3-([1,1′-biphenyl]-4-ylthio)propyl acrylate, 3-([1,1′-biphenyl]-4-ylthio)propyl (meth)acrylate, 4-([1,1′-biphenyl]-4-ylthio)butyl acrylate, 4-([1,1′-biphenyl]-4-ylthio)butyl (meth)acrylate, 5-([1,1′-biphenyl]-4-ylthio)pentyl acrylate, 5-([1,1′-biphenyl]-4-ylthio)pentyl (meth)acrylate, 6-([1,1′-biphenyl]-4-ylthio)hexyl acrylate, 6-([1,1′-biphenyl]-4-ylthio)hexyl (meth)acrylate, 7-([1,1′-biphenyl]-4-ylthio)heptyl acrylate, 7-([1,1′-biphenyl]-4-ylthio)heptyl (meth)acrylate, 8-([1,1′-biphenyl]-4-ylthio)octyl acrylate, 8-([1,1′-biphenyl]-4-ylthio)octyl (meth)acrylate, 9-([1,1′-biphenyl]-4-ylthio)nonyl acrylate, 9-([1,1′-biphenyl]-4-ylthio)nonyl (meth)acrylate, 10-([1,1′-biphenyl]-4-ylthio)decyl acrylate, 10-([1,1′-biphenyl]-4-ylthio)decyl (meth)acrylate, 2-hydroxy-2-phenoxyethyl acrylate, 2-hydroxy-2-phenoxyethyl (meth)acrylate, 2-hydroxy-2-(naphthalen-2-yloxy)ethyl acrylate, 2-hydroxy-2-(naphthalen-2-yloxy)ethyl (meth)acrylate, 2-([1,1′-biphenyl]-4-yloxy)ethyl acrylate, 2-([1,1′-biphenyl]-4-yloxy)ethyl (meth)acrylate, 2-(2-phenoxyethoxyl)ethyl acrylate, 2-(2-phenoxyethoxyl)ethyl (meth)acrylate, 2-(phenoxymethoxy)ethyl acrylate, 2-(phenoxymethoxy)ethyl (meth)acrylate, 2-(([1,1′-biphenyl]-4-yloxy)methoxy)ethyl acrylate, 2-(([1,1′-biphenyl]-4-yloxy)methoxy)ethyl (meth)acrylate, 2-((naphthalen-2-yloxy)methoxy)ethyl acrylate, 2-((naphthalen-2-yloxy)methoxy)ethyl (meth)acrylate, 2-((phenylthio)methoxy)ethyl acrylate, 2-((phenylthio)methoxy)ethyl (meth)acrylate, 2-((naphthalen-2-ylthio)methoxy)ethyl acrylate, 2-((naphthalen-2-ylthio)methoxy)ethyl (meth)acrylate, 2,2′-(4,4′-(9H-fluorene-9,9-diyl)bis(4,1-phenylene))bis(oxy)bis(ethane-2,1-diyl)diacrylate, 2,2′-(4,4′-(9H-fluorene-9,9-diyl)bis(4,1-phenylene))bis(oxy)bis(ethane-2,1-diyl)bis(2-methylacrylate), 3,3′-(4,4′-(9H-fluorene-9,9-diyl)bis(4,1-phenylene))bis(oxy)bis(propane-3,1-diyl)diacrylate, 3,3′-(4,4′-(9H-fluorene-9,9-diyl)bis(4,1-phenyl ene))bis(oxy)bis(propane-3,1-diyl)bis(2-methylacrylate), 2,2′-(4,4′-(9H-fluorene-9,9-diyl)bis(4,1-phenylene))bis(sulfonediyl)bis(ethane-2,1-diyl)diacrylate, 2,2′-(4,4′-(9H-fluorene-9,9-diyl)bis(4,1-phenylene))bis(sulfonediyl)bis(ethane-2,1-diyl)bis(2-methylacrylate), 3,3′-(4,4′-(9H-fluorene-9,9-diyl)bis(4,1-phenylene))bis(sulfonediyl)bis(propane-3,1-diyl)diacrylate, 3,3′-(4,4′-(9H-fluorene-9,9-diyl)bis(4,1-phenylene))bis(sulfonediyl)bis(propane-3,1-diyl)bis(2-methylacrylate), 2,2′-(4,4′-(4,4′-(9H-fluorene-9,9-diyl)bis(4,1-phenylene))bis(oxy)bis(4,1-phenylene))bis(oxy)bis(ethane-2,1-diyl)diacrylate, 2,2′-(4,4′-(4,4′-(9H-fluorene-9,9-diyl)bis(4,1-phenylene))bis(oxy)bis(4,1-phenylene))bis(oxy)bis(ethane-2,1-diyl)bis(2-methylacrylate), 3,3′-(4,4′-(4,4′-(9H-fluorene-9,9-diyl)bis(4,1-phenylene))bis(oxy)bis(4,1-phenylene))bis(oxy)bis(propane-3,1-diyl)diacrylate, 3,3′-(4,4′-(4,4′-(9H-fluorene-9,9-diyl)bis(4,1-phenylene))bis(oxy)bis(4,1-phenylene))bis(oxy)bis(propane-3,1-diyl)bis(2-methylacrylate), 2,2′-(4,4′-(4,4′-(9H-fluorene-9,9-diyl)bis(4,1-phenylene))bis(sulfonediyl)bis(4,1-phenylene))bis(oxy)bis(ethane-2,1-diyl)diacrylate, 2,2′-(4,4′-(4,4′-(9H-fluorene-9,9-diyl)bis(4,1-phenylene))bis(sulfonediyl)bis(4,1-phenylene))bis(oxy)bis(ethane-2,1-diyl)bis(2-methylacrylate), 3,3′-(4,4′-(4,4′-(9H-fluorene-9,9-diyl)bis(4,1-phenylene))bis(sulfonediyl)bis(4,1-phenylene))bis(oxy)bis(propane-3,1-diyl)diacrylate, 3,3′-(4,4′-(4,4′-(9H-fluorene-9,9-diyl)bis(4,1-phenylene))bis(sulfonediyl)bis(4,1-phenylene))bis(oxy)bis(propane-3,1-diyl)bis(2-methylacrylate), 2,2′-(2,2′-(4,4′-(9H-fluorene-9,9-diyl)bis(4,1-phenylene))bis(oxy)bis(ethane-2,1-diyl))bis(oxy)bis(ethane-2,1-diyl)diacrylate, 2,2′-(2,2′-(4,4′-(9H-fluorene-9,9-diyl)bis(4,1-phenylene))bis(oxy)bis(ethane-2,1-diyl))bis(oxy)bis(ethane-2,1-diyl)bis(2-methylacrylate), 2,2′-(2,2′-(4,4′-(9H-fluorene-9,9-diyl)bis(4,1-phenylene))bis(sulfonediyl)bis(ethane-2,1-diyl))bis(oxy)bis(ethane-2,1-diyl)diacrylate, 2,2′-(2,2′-(4,4′-(9H-fluorene-9,9-diyl)bis(4,1-phenylene))bis(sulfonediyl)bis(ethane-2,1-diyl))bis(oxy)bis(ethane-2,1-diyl)bis(2-methylacrylate), 2,2′-(4,4′-oxybis(4,1-phenylene)bis(oxy))bis(ethane-2,1-diyl)diacrylate, 2,2′-(4,4′-oxybis(4,1-phenylene)bis(oxy))bis(ethane-2,1-diyl)bis(2-methylacrylate), 2,2′-(4,4′-oxybis(4,1-phenylene)bis(sulfonediyl))bis(ethane-2,1-diyl)diacrylate, 2,2′-(4,4′-oxybis(4,1-phenylene)bis(sulfonediyl))bis(ethane-2,1-diyl)bis(2-methylacrylate), 2,2′-(4,4′-thiobis(4,1-phenylene)bis(oxy))bis(ethane-2,1-diyl)diacrylate, 2,2′-(4,4′-thiobis(4,1-phenylene)bis(oxy))bis(ethane-2,1-diyl)bis(2-methylacrylate), 2,2′(4,4′-thiobis(4,1-phenylene)bis(sulfonediyl))bis(ethane-2,1-diyl)diacrylate, 2,2′-(4,4′-thiobis(4,1-phenylene)bis(sulfonediyl))bis(ethane-2,1-diyl)bis(2-methylacrylate), 2,2′-(3,3′-(4,4′-oxybis(4,1-phenylene)bis(oxy))bis(propane-3,1-diyl))bis(oxy)bis(ethane-2,1-diyl)diacrylate, 2,2′-(3,3′-(4,4′-oxybis(4,1-phenylene)bis(oxy))bis(propane-3,1-diyl))bis(oxy)bis(ethane-2,1-diyl)bis(2-methylacrylate), 2,2′-(3,3′-(4,4′-thiobis(4,1-phenylene)bis(oxy))bis(propane-3,1-diyl))bis(oxy)bis(ethane-2,1-diyl)diacrylate, 2,2′-(3,3′-(4,4′-thiobis(4,1-phenylene)bis(oxy))bis(propane-3,1-diyl))bis(oxy)bis(ethane-2,1-diyl)bis(2-methylacrylate), 2.2′-(3,3′-(4,4′-oxybis(4,1-phenylene)bis(sulfonediyl))bis(propane-3,1-diyl))bis(oxy)bis(ethane-2,1-diyl)diacrylate, 2,2′-(3,3′-(4,4′-oxybis(4,1-phenylene)bis(sulfonediyl))bis(propane-3,1-diyl))bis(oxy)bis(ethane-2,1-diyl)bis(2-methylacrylate), 2,2′-(3,3′-(4,4′-thiobis(4,1-phenylene)bis(sulfonediyl))bis(propane-3,1-diyl))bis(oxy)bis(ethane-2,1-diyl)diacrylate, 2,2′-(4,4′-(propane-2,2-diyl)bis(4,1-phenylene))bis(oxy)bis(ethane-2,1-diyl)diacrylate, 2,2′-(4,4′-(propane-2,2-diyl)bis(4,1-phenylene))bis(oxy)bis(ethane-2,1-diyl)bis(2-methylacrylate), 2,2′-(4,4′-(propane-2,2-diyl)bis(4,1-phenylene))bis(sulfonediyl)bis(ethane-2,1-diyl)diacrylate, 2,2′-(4,4′-(propane-2,2-diyl)bis(4,1-phenylene))bis(sulfonediyl)bis(ethane-2,1-diyl)bis(2-methylacrylate), 2,2′-(2,2′-(4,4′-(propane-2,2-diyl)bis(4,1-phenylene))bis(oxy)bis(ethane-2,1-diyl))bis(oxy)bis(ethane-2,1-diyl)diacrylate, 2,2′-(2,2′-(4,4′-(propane-2,2-diyl)bis(4,1-phenylene))bis(oxy)bis(ethane-2,1-diyl))bis(oxy)bis(ethane-2,1-diyl)bis(2-methylacrylate), 2,2′-(2,2′-(4,4′-(propane-2,2-diyl)bis(4,1-phenylene))bis(sulfonediyl)bis(ethane-2,1-diyl))bis(oxy)bis(ethane-2,1-diyl)diacrylate, 2,2′-(2,2′-(4,4′-(propane-2,2-diyl)bis(4,1-phenylene))bis(sulfonediyl)bis(ethane-2,1-diyl))bis(oxy)bis(ethane-2,1-diyl)bis(2-methylacrylate), 2,2′-(2,2′-(2,2′-(4,4′-(propane-2,2-diyl)bis(4,1-phenylene))bis(oxy)bis(ethane-2,1-diyl))bis(oxy)bis(ethane-2,1-diyl))bis(oxy)bis(ethane-2,1-diyl)diacrylate, 2,2′-(2,2′-(2,2′-(4,4′-(propane-2,2-diyl)bis(4,1-phenylene))bis(oxy)bis(ethane-2,1-diyl))bis(oxy)bis(ethane-2,1-diyl))bis(oxy)bis(ethane-2,1-diyl)bis(2-methylacrylate), 2,2′-(2,2′-(2,2′-(4,4′-(propane-2,2-diyl)bis(4,1-phenylene))bis(sulfonediyl)bis(ethane-2,1-diyl))bis(oxy)bis(ethane-2,1-diyl))bis(oxy)bis(ethane-2,1-diyl)diacrylate, 2,2′-(2,2′-(2,2′-(4,4′-(propane-2,2-diyl)bis(4,1-phenylene))bis(sulfonediyl)bis(ethane-2,1-diyl))bis(oxy)bis(ethane-2,1-diyl))bis(oxy)bis(ethane-2,1-diyl)bis(2-methylacrylate), 2,2′-(2,2′-(2,2′-(4,4′-oxybis(4,1-phenylene)bis(oxy))bis(ethane-2,1-diyl))bis(oxy)bis(ethane-2,1-diyl)bis(oxy)bis(ethane-2,1-diyl)diacrylate, 2,2′-(2,2′-(2,2′-(4,4′-oxybis(4,1-phenylene)bis(oxy))bis(ethane-2,1-diyl))bis(oxy)bis(ethane-2,1-diyl)bis(oxy)bis(ethane-2,1-diyl)bis(2-methylacrylate), 2,2′-(2,2′-(2,2′-(4,4′-thiobis(4,1-phenylene)bis(oxy))bis(ethane-2,1-diyl))bis(oxy)bis(ethane-2,1-diyl)bis(oxy)bis(ethane-2,1-diyl)diacrylate, 2,2′-(2,2′-(2,2′-thiobis(4,1-phenyl ene)bis(oxy))bis(ethane-2,1-diyl))bis(oxy)bis(ethane-2,1-diyl)bis(oxy)bis(ethane-2,1-diyl)bis(2-methylacrylate), 2,2′-(2,2′-(2,2′-(4,4′-thiobis(4,1-phenylene)bis(sulfonediyl))bis(ethane-2,1-diyl)bis(oxy)bis(ethane-2,1-diyl))bis(oxy)bis(ethane-2,1-diyl)diacrylate, 2,2′-(2,2′-(2,2′-(4,4′-thiobis(4,1-phenylene)bis(sulfonediyl))bis(ethane-2,1-diyl)bis(oxy)bis(ethane-2,1-diyl))bis(oxy)bis(ethane-2,1-diyl)bis(2-methylacrylate), polyester urethane diacrylate, tripropylene glycol diacrylate, urethane acrylate, epoxy acrylate, phenylthio ethyl(methyl)acrylate, isobornyl acrylate, 2-phenoxyethyl acrylate, phenoxyethyl(methyl)acrylate, phenoxy-2-methyl-ethyl(methyl)acrylate, phenoxyethoxyethyl (methyl)acrylate, phenoxybenzylacrylate, 3-phenoxy-2-hydroxypropyl(methyl)acrylate, 2-1-naphthyloxyethyl (methyl)acrylate, 2-2-naphthyloxyethyl(methyl)acrylate, 2-1-naphthylthioethyl(methyl)acrylate, or 2-2-naphthylthioethyl(methyl)acrylate, which may be used alone or in combination of two or more.

The prism sheet according to one exemplary embodiment of the present invention may have a structure in which the cured product of the organic-inorganic hybrid composition according to one exemplary embodiment of the present invention is formulated into a prism sheet per se.

By way of example, the prism sheet may have a structure to form a pattern in which triangular prism shapes including ridge/valley-shaped tips are repeatedly arranged. By way of another example, the prism sheet may have a structure in which one of the ridge/valley-shaped tips in the pattern in which the triangular prism shapes are repeatedly arranged is formed in a round shape.

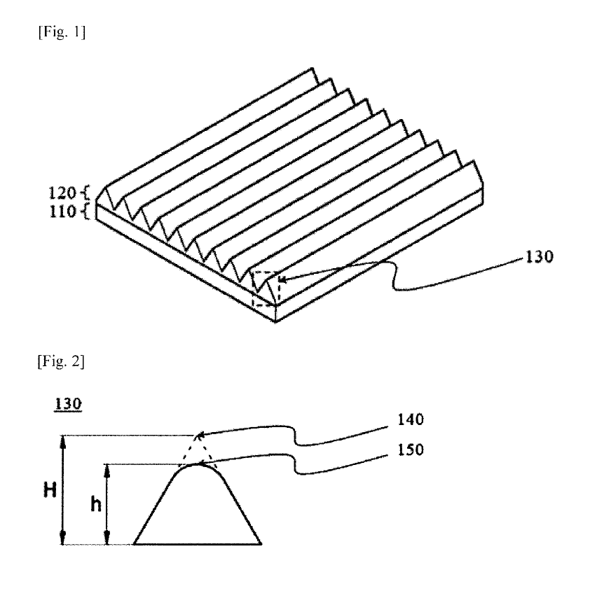

For example, the prism sheet may have a structure in which a tip of one of ridges and valleys is formed in a round shape. Hereinafter, the prism sheet will be described in further detail with reference to FIGS. 1 and 2.

FIG. 1 is a perspective view schematically showing a shape of a prism sheet. Referring to FIG. 1, the prism sheet 100 includes a base film 110, and a pattern portion 120 disposed on the base film 110. The pattern portion 120 includes a plurality of triangular prisms 130 having a pattern structure in which ridge/valley-shaped tips are repeatedly arranged. Each of the tips of the triangular prisms 130 may be defined as a line formed when two inclined planes are intersected, and the cross-sectional shape may be defined as a point. In this case, a distance between pitches of the adjacent triangular prisms 130 may be in a range of 9 μm to 25 and the thickness of the pattern portion 120 may be in a range of 18 μm to 50 μm.

On the other hand, the tip of each of the triangular prisms 130 may be formed in a round shape, and thus will be described with reference to FIG. 2.

FIG. 2 is a schematic view of a triangular prism in which a valley is in a round shape.

Referring to FIG. 2, tips of the triangular prisms 130 may have a round shape. The effect of the triangular prisms 130 may vary according to the height at which the round shape of the tip is formed. That is, the luminance and a luminance uniformity effect may vary according to the ratio (h/H) of a second height h between the bottom side and a round-shaped vertex 150 of the triangular prism 130 in which the tip of the ridge is formed in a round shape to a first height H between the bottom side and an imaginary apex 140 of the triangular prism 130.

The shape of the prism sheet according to one exemplary embodiment of the present invention is not particularly limited, but may be applied to prism sheets whose shapes are changed, replaced, or modified without departing from the scope of the present invention apparent to those skilled in the related art.

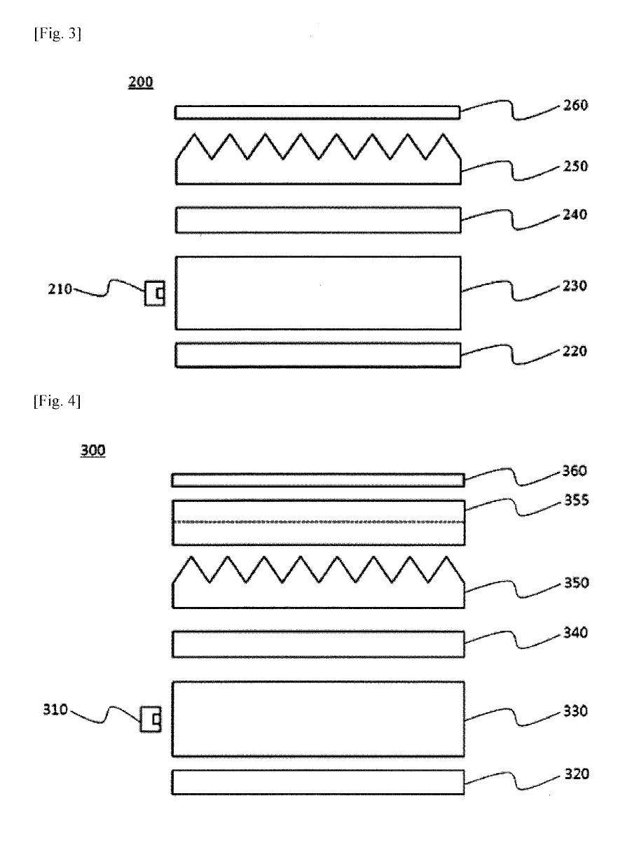

Also, the prism sheet may be applied to various optical devices. For example, the prism sheet may be applied to backlight units (BLU) of the optical devices. The backlight unit will be described below with reference to FIGS. 3 and 4.

FIGS. 3 and 4 are exploded views showing schematic configurations of backlight units, respectively.

Referring to FIG. 3, the backlight unit 200 may include a light source 210, a reflective plate 220, a light guide plate 230, a diffusion film 240, a prism sheet 250 and a protective sheet 260.

The light source 210 is a constituent part configured to generate light for the first time. For example, a light emitting diode (LED), a cold cathode fluorescent lamp (CCFL), and the like may be used as the light source 210. Light emitted from the light source 210 is incident on the light guide plate 230, and totally reflected inside the light guide plate 230. However, since light incident at an incidence angle smaller than a critical angle is not totally reflected on but penetrates the light guide plate 230, the light may emit upwards and downwards. In this case, the reflective plate 220 serves to reflect the light emitted downwards to be incident again on the light guide plate 230, thereby improving luminous efficacy.

The diffusion film 240 serves to diffuse the light emitted through a top surface of the light guide plate 230 to make the luminance uniform and widen a viewing angle. However, the light passing through the diffusion film 240 has poor front emission luminance. The prism sheet 250 serves to refract the light incident from the diffusion film 240, condense the light so that the light is incident perpendicularly to an LCD device and emit the light, thereby enhancing emission luminance of the light directed toward the front of the LCD device. The backlight unit 200 may prevent the prism sheet 250 from being scratched due to the presence of the protective sheet 260.

Referring to FIG. 4, the backlight unit 300 may include a light source 310, a reflective plate 320, a light guide plate 330, a diffusion film 340, a first prism sheet 350, a second prism sheet 355, and a protective sheet 360. When the backlight unit 300 shown in FIG. 4 is compared to the backlight unit 200 shown in FIG. 3, the backlight unit 300 has a structure in which a second prism sheet 355 is further formed between the first prism sheet 350 and the protective sheet 360. The second prism sheet 355 has a structure facing the first prism sheet 350 which is rotated at an angle of 90°. That is, the second prism sheet 355 is disposed so that a surface of the second prism sheet 355 in which ridges and valleys are repeatedly arranged faces the first prism sheet 350, and is rotated at an angle of 90° with respect to a surface of the first prism sheet 350 in which ridges and valleys are repeatedly arranged.

Further, the present invention is directed to provide various types of optical devices including the optical sheet. The composition or the cured product of the composition may be used in materials and parts included in the optical devices. By way of example, the composition or the cured product of the composition may be included in the form of an optical sheet in the optical devices.

### EXAMPLES

Hereinafter, the present invention will be described in further detail with reference to Examples below. However, it should be understood that the following Examples are given by way of illustration of the present invention only, and are not intended to limit the scope of the present invention.

### Examples 1 to 39

As an aluminum precursor, an aluminum isopropyl oxide was added to 500 g of a zirconium acetate solution, which included ZrO₂ at approximately 21% by weight based on the total weight of the solution, at a content as listed in the following Table 1, and stirred. In this case, chromium acetate monohydrate was further added as a chromium precursor.

In addition, tin acetate as a tin precursor, or cerium acetylacetonate as a cerium precursor was added to 500 g of a zirconium acetate solution, which included ZrO₂ at approximately 21% by weight based on the total weight of the solution, at contents as listed in the following Table 1, and stirred.

In Table 1, the respective contents of the zirconium precursor, the aluminum precursor, the tin precursor, and the cerium precursor are represented by the “percentages by weight” of the corresponding components, based on the total weight of the solution. In this case, the content of the chromium precursor is represented by the “parts by weight” when it is assumed that the sum of the weights of the zirconium precursor, the aluminum precursor, the tin precursor, and the cerium precursor is set to 100 parts by weight.

TABLE 1

| | Zirconium | Aluminum | Tin | Cerium | Chromium |
|---|---|---|---|---|---|
| | precursor | precursor | precursor | precursor | precursor |
| | (% by | (% by | (% by | (% by | (part by |
| No. | weight) | weight) | weight) | weight) | weight) |
| Example 1 | 99.5 | 0.5 | — | — | — |
| Example 2 | 97 | 3 | — | — | — |
| Example 3 | 97 | 3 | — | — | 0.2 |
| Example 4 | 90 | 10 | — | — | — |
| Example 5 | 85 | 15 | — | — | — |
| Example 6 | 80 | 20 | — | — | — |
| Example 7 | 75 | 25 | — | — | — |
| Example 8 | 85 | 15 | — | — | 0.1 |
| Example 9 | 85 | 15 | — | — | 0.2 |
| Example 10 | 85 | 15 | — | — | 1.0 |
| Example 11 | 85 | 15 | — | — | 5.0 |
| Example 12 | 85 | 15 | | | 10.0 |
| Example 13 | 85 | 15 | — | — | 15.0 |
| Example 14 | 99.5 | — | 0.5 | — | — |
| Example 15 | 97 | — | 3 | — | — |
| Example 16 | 97 | — | 3 | — | 0.2 |
| Example 17 | 90 | — | 10 | — | — |
| Example 18 | 85 | — | 15 | — | — |
| Example 19 | 80 | — | 20 | — | — |
| Example 20 | 75 | — | 25 | — | — |
| Example 21 | 85 | — | 15 | — | 0.1 |
| Example 22 | 85 | — | 15 | — | 0.2 |
| Example 23 | 85 | — | 15 | — | 1.0 |
| Example 24 | 85 | — | 15 | — | 5.0 |
| Example 25 | 85 | — | 15 | — | 10.0 |
| Example 26 | 85 | — | 15 | — | 15.0 |
| Example 27 | 99.5 | — | — | 0.5 | — |
| Example 28 | 97 | — | — | 3 | — |
| Example 29 | 97 | — | — | 3 | 0.2 |
| Example 30 | 90 | — | — | 10 | — |
| Example 31 | 85 | — | — | 15 | — |
| Example 32 | 80 | — | — | 20 | — |
| Example 33 | 75 | — | — | 25 | — |
| Example 34 | 85 | — | — | 15 | 0.1 |
| Example 35 | 85 | — | — | 15 | 0.2 |
| Example 36 | 85 | — | — | 15 | 1.0 |
| Example 37 | 85 | — | — | 15 | 5.0 |
| Example 38 | 85 | — | — | 15 | 10.0 |
| Example 39 | 85 | — | — | 15 | 15.0 |

As listed in Table 1, the precursors were added to a solution of zirconium acetate which was a zirconium precursor, and then completely dissolved in the solution of zirconium acetate by means of a sonication process. The dissolved mixed solution was transferred to a 1 L liner autoclave, and a reaction temperature of the autoclave was set so that an inner pressure of the autoclave reached 30 atm. When the inner pressure of the autoclave reached 30 atm, the autoclave was maintained at a pressure of 30 atm for 5 hours to prepare an inorganic sample. The prepared inorganic sample was passed through a dryer to produce metal-containing zirconia particles from which moisture included in the inorganic sample was removed.

Each of Examples 1 to 39, the curable resin and the like were mixed at contents as listed in the following Table 2, based on approximately 60 g of the metal-containing zirconia particles from which moisture was removed.

TABLE 2

| | | Content |
|---|---|---|
| Type | Component | (g) |
| Constituent compound | PBA (phenoxybenzyl acrylate) | 35 |
| of curable resin | | |
| Surface modifying | MEEA (2-2-2-methoxyethoxy- | 10 |
| agent | ethoxyacetic acid) | |
| Solvent | Methanol | 90 |

The mixture obtained by mixing the components at the contents as listed in Table 2 was reacted at 60° C. for 60 minutes, and then dried under a vacuum to remove the solvent, thereby producing organic-inorganic hybrid compositions according to Examples 1 to 39 of the present invention.

### Comparative Examples 1 and 2

Organic-inorganic hybrid compositions were produced in the same manner as in Examples 1 to 39, except that the contents of the respective metal components were adjusted as listed in the following Table 3. Referring to the following Table 3, the composition according to Comparative Example 1 included only a zirconium precursor, and the composition according to Comparative Example 2 further included a chromium precursor at approximately 5 parts by weight, based on 100 parts by weight of the zirconium precursor.

TABLE 3

| | Zirconium precursor | Chromium precursor |
|---|---|---|
| No. | (parts by weight) | (parts by weight) |
| Comparative Example 1 | 100 | — |
| Comparative Example 2 | 100 | 5 |

### Experimental Example 1

### Experiment for Measurement of Luminance

The organic-inorganic hybrid compositions according to Examples 1 to 39 and Comparative Examples 1 and 2 were used to prepare prism sheets 1 to 39 and reference sheets 1 and 2. Specifically, the respective organic-inorganic hybrid compositions according to Examples 1 to 39 and Comparative Examples 1 and 2 were mixed with an additional solution including difunctional urethane acrylate, tetrafunctional urethane acrylate, and diphenyl(2,4,6-trimethylbenzoyl)phosphine oxide (TPO), and stirred for approximately 3 hours to prepare coating compositions. The coating compositions were coated on a PET film, and cured using a metal lamp to manufacture prism sheets 1 to 39 and reference sheets 1 and 2. In this case, in each of the prism sheets 1 to 39 and the reference sheets 1 and 2, a distance between pitches of adjacent triangular prisms was approximately 21 μm. Also, the total thickness of the prism sheet (or a reference sheet) including the PET film was approximately 87.5 μm.

Each of the prism sheets 1 to 39 and the reference sheet 2 were measured for luminance. The luminance was measured as the percentage relative to the luminance of the reference sheet 1 measured using a luminance measuring machine (BM7 (trade name) commercially available from Topcon Corporation) when it was assumed that the luminance of the reference sheet 1 was 100%. Each of the prism sheets 1 to 39 and the reference sheets 1 and 2 was assembled into an optical module including a light source, a light guide plate, and a diffusion sheet, and the optical modules to which the prism sheets 1 to 39 and the reference sheets 1 and 2 were applied were measured for luminance under the same conditions.

Also, each of the organic-inorganic hybrid compositions according to Examples 1 to 39 and Comparative Examples 1 and 2 was measured for liquid refractive index. The liquid refractive index was measured using an Abbe refractometer (DR-M2 (trade name) commercially available from ATAGO Co., Ltd., Japan).

The luminance values and the liquid refractive indexes measured as described above are listed in the following Table 4.

TABLE 4

| No. | luminance | liquid refractive index |
|---|---|---|
| Example 1 | 104% | 1.602 |
| Example 2 | 117% | 1.601 |
| Example 3 | 117% | 1.601 |
| Example 4 | 115% | 1.597 |
| Example 5 | 113% | 1.592 |
| Example 6 | 110% | 1.586 |
| Example 7 | 108% | 1.581 |
| Example 8 | 113% | 1.592 |
| Example 9 | 113% | 1.592 |
| Example 10 | 111% | 1.588 |
| Example 11 | 108% | 1.581 |
| Example 12 | 106% | 1.577 |
| Example 13 | 100% | 1.573 |
| Example 14 | 104% | 1.602 |
| Example 15 | 117% | 1.601 |
| Example 16 | 117% | 1.601 |
| Example 17 | 115% | 1.597 |
| Example 18 | 113% | 1.592 |
| Example 19 | 110% | 1.586 |
| Example 20 | 108% | 1.581 |
| Example 21 | 113% | 1.592 |
| Example 22 | 113% | 1.592 |
| Example 23 | 111% | 1.588 |
| Example 24 | 108% | 1.581 |
| Example 25 | 106% | 1.577 |
| Example 26 | 100% | 1.573 |
| Example 27 | 105% | 1.602 |
| Example 28 | 118% | 1.601 |
| Example 29 | 118% | 1.601 |
| Example 30 | 116% | 1.597 |
| Example 31 | 114% | 1.592 |
| Example 32 | 111% | 1.586 |
| Example 33 | 109% | 1.581 |
| Example 34 | 114% | 1.592 |
| Example 35 | 114% | 1.592 |
| Example 36 | 112% | 1.588 |
| Example 37 | 109% | 1.581 |
| Example 38 | 107% | 1.577 |
| Example 39 | 102% | 1.573 |
| Comparative Example 1 | 100% | 1.602 |
| Comparative Example 2 | 95% | 1.602 |

Referring to Table 4, it could be seen that the optical modules to which the prism sheets 1 to 12, 14 to 25, and 27 to 39 prepared respectively using the compositions according to Examples 1 to 12, 14 to 25, and 27 to 39 of the present invention were applied had higher luminance values than the optical modules to which the reference sheets 1 and 2 were applied. Also, it could be seen that, although the compositions according to Examples 2 to 13, 15 to 25, and 27 to 39 of the present invention had relatively lower liquid refractive indices than the compositions of Comparative Examples 1 and 2, the optical modules to which the prism sheets prepared using the compositions of Examples 2 to 13, 15 to 25, and 27 to 39 were applied has higher luminance values.

Particularly, it could be seen that the liquid refractive indices of the compositions according to Examples 1, 14, and 27 were substantially the same as those of the compositions according to Comparative Examples 1 and 2, but the optical modules to which the prism sheets 1, 14, and 27 prepared using the compositions according to Examples 1, 14, and 27 were applied has higher luminance values than the optical modules to which the reference sheets 1 and 2 were applied.

In addition, it could be seen that the liquid refractive indices of the compositions according to Examples 13 and 26 were lower than those of the compositions according to Comparative Examples 1 and 2, but the luminance values of the optical modules to which the prism sheets 13 and 26 prepared using the compositions of Examples 13 and 26 were applied were substantially similar to those of the optical modules to which the reference sheets 1 and 2 were applied.

### Experimental Example 2

### Experiment for Measurement of Light Transmittance

An additional solution including difunctional urethane acrylate, tetrafunctional urethane acrylate, and diphenyl(2,4,6-trimethylbenzoyl)phosphine oxide (TPO) was added to the respective organic-inorganic hybrid compositions according to Examples 1 to 39 and Comparative Examples 1 and 2, and stirred for approximately 3 hours to prepare coating compositions. UV rays were applied to the coating compositions to manufacture flat films 1 to 39 and reference films 1 and 2. Each of the flat films 1 to 39 and the reference films 1 and 2 was measured for light transmittance using a UV-Visible spectrophotometer (Manufacturer: VARIAN, Model name: CARRY 4000, Lamp: Mercury lamp). Upon measurement of the light transmittance, the thickness of each film was 60 μm, and the wavelength of the light radiated from the light source was 400 nm. The results are listed in the following Table 5.

TABLE 5

| | Light |
|---|---|
| No. | transmittance (%) |
| Example 1 | 70% |
| Example 2 | 77% |
| Example 3 | 77% |
| Example 4 | 78% |
| Example 5 | 80% |
| Example 6 | 81% |
| Example 7 | 81% |
| Example 8 | 80% |
| Example 9 | 80% |
| Example 10 | 80% |
| Example 11 | 78% |
| Example 12 | 75% |
| Example 13 | 70% |
| Example 14 | 70% |
| Example 15 | 77% |
| Example 16 | 77% |
| Example 17 | 78% |
| Example 18 | 80% |
| Example 19 | 81% |
| Example 20 | 81% |
| Example 21 | 80% |
| Example 22 | 80% |
| Example 23 | 80% |
| Example 24 | 78% |
| Example 25 | 75% |
| Example 26 | 70% |
| Example 27 | 72% |
| Example 28 | 79% |
| Example 29 | 79% |
| Example 30 | 80% |
| Example 31 | 82% |
| Example 32 | 83% |
| Example 33 | 83% |
| Example 34 | 82% |
| Example 35 | 82% |
| Example 36 | 82% |
| Example 37 | 80% |
| Example 38 | 77% |
| Example 39 | 72% |
| Comparative | 66% |
| Example 1 | |
| Comparative | 60% |
| Example 2 | |

Referring to Table 5, it could be seen that the flat sheets prepared using the organic-inorganic hybrid compositions according to Examples 1 to 39 of the present invention had higher transmittance values than the reference sheets prepared using the compositions according to Comparative Examples 1 and 2. Particularly, it could be seen that the transmittance values of the flat sheets prepared using the organic-inorganic hybrid compositions according to Examples 5 to 7, 18 to 23, and 30 to 37 were higher than those of the other flat sheets and the reference sheets, and that the transmittance tended to decrease as the content of chromium increased for the entire weights of the compositions.

### Experimental Example 3

### Observation of Occurrence of Yellowing

Promotion weathering tests were performed on the respective prism sheets 1 to 39 and reference sheets 1 and 2, which were prepared in substantially the same manner as in Experimental Example 1, according to the ASTM D 4674 conditions. The tests were performed using a promotion weathering tester (Model name: QUV/spray), and the prism sheets having a structure to form a pattern in which triangular prism shapes were repeatedly arranged were kept at 50° C. 15 minutes as the conditions. Thereafter, the occurrence of yellowing on the sheets was determined by measuring the color coordinates of the sheets using a BM7 luminance colorimeter. A higher value from the color coordinates means that the corresponding products are more vulnerable to yellowing. The analytic results are listed in the following Table 6.

TABLE 6

| | Change in color |
|---|---|
| No. | coordinates (Ay) |
| Example 1 | 0.0035 |
| Example 2 | 0.003 |
| Example 3 | 0.0023 |
| Example 4 | 0.0027 |
| Example 5 | 0.0027 |
| Example 6 | 0.0027 |
| Example 7 | 0.0027 |
| Example 8 | 0.0026 |
| Example 9 | 0.0023 |
| Example 10 | 0.0020 |
| Example 11 | 0.0018 |
| Example 12 | 0.0015 |
| Example 13 | 0.0010 |
| Example 14 | 0.0035 |
| Example 15 | 0.003 |
| Example 16 | 0.0023 |
| Example 17 | 0.0027 |
| Example 18 | 0.0027 |
| Example 19 | 0.0027 |
| Example 20 | 0.0027 |
| Example 21 | 0.0026 |
| Example 22 | 0.0023 |
| Example 23 | 0.0020 |
| Example 24 | 0.0018 |
| Example 25 | 0.0015 |
| Example 26 | 0.0010 |
| Example 27 | 0.0033 |
| Example 28 | 0.0028 |
| Example 29 | 0.0021 |
| Example 30 | 0.0025 |
| Example 31 | 0.0025 |
| Example 32 | 0.0025 |
| Example 33 | 0.0025 |
| Example 34 | 0.0024 |
| Example 35 | 0.0021 |
| Example 36 | 0.0018 |
| Example 37 | 0.0016 |
| Example 38 | 0.0013 |
| Example 39 | 0.0008 |
| Comparative Example 1 | 0.0037 |
| Comparative Example 2 | 0.0023 |

Referring to Table 6, it could be seen that the changes in color coordinates of the prism sheets 1 to 39 prepared using the organic-inorganic hybrid compositions according to Examples 1 to 39 of the present invention were smaller than that of the reference sheet 1 prepared using the composition according to Comparative Example 1. That is, it could be seen that the degrees of discoloration of the prism sheets 1 to 39 were lower than that of the reference sheet 1 even with the elapse of time.

Also, it could be seen that the changes in color coordinates of the prism sheets prepared using the organic-inorganic hybrid compositions according to Examples 11 to 13, 24 to 26, and 36 to 39 of the present invention were smaller than that of the reference sheet 2 prepared using the composition according to Comparative Example 2. As a result, it was confirmed that chromium was able to suppress the occurrence of yellowing, and that the compositions capable of satisfying all the luminance, the light transmittance, and the suppression of the occurrence of yellowing were the compositions according to one exemplary embodiment of the present invention.

1. An organic-inorganic hybrid composition comprising:
zirconia particles containing at least one metal selected from the group consisting of aluminum (Al), tin (Sn), and cerium (Ce); and
a curable resin in which the metal-containing zirconia particles are dispersed.

2. The organic-inorganic hybrid composition of claim 1,
wherein the metal in the metal-containing zirconia particles is present at a content of 0.1 part by weight to 20 parts by weight, based on 100 parts by weight of the zirconia particles.

3. The organic-inorganic hybrid composition of claim 1,
wherein the metal-containing zirconia particles further comprises chromium (Cr).

4. The organic-inorganic hybrid composition of claim 3,
wherein chromium is further comprised at a content of 0.01 part by weight to 10 parts by weight, based on 100 parts by weight of the metal-containing zirconia particles, when the metal-containing zirconia particles further comprises chromium.

5. The organic-inorganic hybrid composition of claim 1, wherein the metal-containing zirconia particles are present at a content of 5 parts by weight to 70 parts by weight, based on 100 parts by weight of the curable resin.

6. The organic-inorganic hybrid composition of claim 1, wherein the metal-containing zirconia particle have an average particle diameter of 1 nm to 80 nm.

7. The organic-inorganic hybrid composition of claim 1, wherein the curable resin is a photocurable or thermosetting resin.

8. The organic-inorganic hybrid composition of claim 7, wherein the curable resin comprises a compound having a structure represented by the following Formula 1: 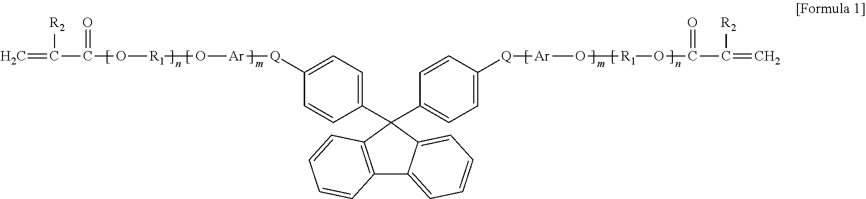
wherein R₁ represents an alkylene group having 2 to 10 carbon atoms, with which a hydroxyl group is unsubstituted or substituted,
R₂ represents hydrogen, or a methyl group,
Ar represents an arylene group having 6 to 40 carbon atoms, or a heteroarylene group having 3 to 40 carbon atoms,
Q represents oxygen, or sulfur, and
m and n each independently represent an integer ranging from 0 to 8.

9. The organic-inorganic hybrid composition of claim 7, wherein the curable resin comprises a compound having a structure represented by the following Formula 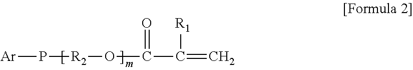
wherein R₁ represents hydrogen, or a methyl group,
R₂ represents an alkylene group having 2 to 10 carbon atoms, with which a hydroxyl group is unsubstituted or substituted,
Ar represents an aryl group having 6 to 40 carbon atoms, or a heteroaryl group having 3 to 40 carbon atoms,
m represents an integer ranging from 0 to 8, and
P represents oxygen, or sulfur.

10. The organic-inorganic hybrid composition of claim 7, wherein the curable resin comprises a compound having a structure represented by the following Formula 3: 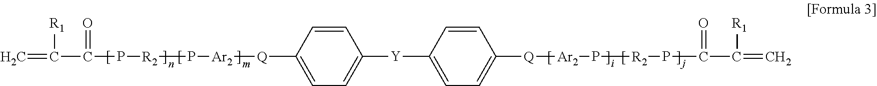
wherein R₁ represents hydrogen, or a methyl group,
R₂ represents an alkylene group having 2 to 10 carbon atoms, with which a hydroxyl group is unsubstituted or substituted,
Ar₁ and Ar₂ each independently represent an aryls group having 6 to 40 carbon atoms, or a heteroarylene group having 3 to 40 carbon atoms,
P represents oxygen, or sulfur,
Q represents oxygen, or sulfur,
i, j, n, and m each independently represent an integer ranging from 0 to 8, and
Y represents —C(CH₃)₂—, —CH₂—, —S—,

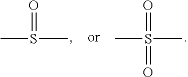

11. The organic-inorganic hybrid composition of claim 1, wherein the metal-containing zirconia particles are surface-modified.

12. The organic-inorganic hybrid composition of claim 11, wherein the metal-containing zirconia particles are surface-modified with at least one substance selected from the group consisting of a silane compound and carboxylic acid.

13. A production method for an organic-inorganic hybrid composition comprising:
preparing zirconia particles containing at least one metal selected from the group consisting of aluminum (Al), tin (Sn), and cerium (CO; and
mixing a curable resin with the metal-containing zirconia particles.

14. The production method of claim 13, wherein the preparing of the metal-containing zirconia particles comprises:
mixing a zirconium precursor with at least one precursor selected from the group consisting of an aluminum precursor, a tin precursor, and a cerium precursor; and
stirring and sonicating a mixture of the precursors.

15. The production method of claim 13, further comprising:
reacting the mixture at a temperature of 200° C. to 350° C. and a pressure of 25 atm to 40 atm for 3 hours to 7 hours after the stirring and sonication.

16. The production method of claim 13, wherein a surface modifying agent is further mixed in the mixing of the curable resin with the metal-containing zirconia particles, and
the metal-containing zirconia particles, the surface modifying agent, and the curable resin are mixed at a temperature of 20° C. to 150° C. for 10 minutes to 20 hours.

17. An optical sheet comprising at least one optical layer having a micropattern formed therein, wherein the optical layer is formed of the composition defined in claim 1.

18. The optical sheet of claim 17, wherein the micropattern formed in the optical layer has a structure in which triangular cross-sectional shapes are repeatedly arranged.

19. An optical device comprising the optical sheet defined in claim 17.
